(19) United States
(12) Patent Application Publication
(10) Pub. No.: US 2026/0177879 A1
(43) Pub. Date: Jun. 25, 2026

(54) PHASE-CHANGE MATERIAL SWITCH

(71) Applicants: Commissariat à I'Énergie Atomique etaux Énergies Alternatives, Paris (FR); Institut Polytechnique de Grenoble, Grenoble Cedex 1 (FR); Universite Grenoble alpes, Saint Martin D'Heres (FR); Centre National de la Recherche Scientifique, Paris (FR)

(72) Inventors: Ayoub Naoui, Grenoble (FR); Bruno Reig, Grenoble (FR); Etienne Perret, Grenoble (FR); Florence Podevin, Grenoble (FR); Ismaël Charlet, Grenoble (FR); Sylvain Guerber, Grenoble (FR)

(73) Assignees: Commissariat à I'Énergie Atomique etaux Énergies Alternatives, Paris (FR); Institut Polytechnique de Grenoble, Grenoble Cedex 1 (FR); Universite Grenoble alpes, (omitted); Centre National de la Recherche Scientifique, Paris (FR)

(21) Appl. No.: 19/423,243

(22) Filed: Dec. 17, 2025

(30) Foreign Application Priority Data
Dec. 19, 2024 (FR) FR2414732

(51) Int. Cl. G02F 1/313

(52) U.S. Cl. CPC G02F 1/313

(57) ABSTRACT

A phase-change material switch, including: a region in said phase-change material connecting first and second conduction electrodes of the switch; and a grating coupler for coupling a laser signal for activating the switch, located opposite a face of the region in said phase-change material.

### TECHNICAL FIELD

The present description generally relates to electronic devices. More specifically, the present description relates to phase-change material switches capable of alternating between a crystalline phase, which is electrically conducting, and an amorphous phase, which is electrically insulating.

### PRIOR ART

Various applications take advantage of phase-change material switches or interrupters to allow or prevent a flow of an electrical current in a circuit. Such switches can especially be used in radio frequency communication applications, for example to switch an antenna between emission and reception modes, to activate a filter corresponding to a frequency band, etc.

However, existing phase-change material switches have various disadvantages.

### SUMMARY OF THE INVENTION

It would be desirable to overcome all or some of the disadvantages of existing phase-change material switches.

To this end, one embodiment provides a phase-change material switch comprising:
a region in said phase-change material connecting first and second conduction electrodes of the switch; and
a grating coupler for coupling a laser signal for activating the switch, located opposite a face of the region in said phase-change material and separated from the region in said phase-change material by a distance in the range from 100 to 300 nm,
   wherein the grating coupler comprises, vertically in line with the region in said phase-change material, an alternation of first regions in a first material having a first optical index and of second regions in a second material having a second optical index strictly lower than the first optical index.

According to one embodiment, the grating coupler is configured to irradiate a constant optical power along a direction of propagation of the laser signal for activating the switch.

According to one embodiment, the first regions are distributed at a constant pitch and have a width decreasing along the direction of propagation of the laser signal for activating the switch.

According to one embodiment, the grating coupler is configured to irradiate a decreasing optical power along a direction of propagation of the laser signal for activating the switch, the first regions being distributed at a constant pitch and having a constant width.

According to one embodiment, the grating coupler is located in the extension of a waveguide, the waveguide comprising a central region in said first material surrounded by a peripheral region in said second material.

According to one embodiment, the first material is silicon nitride and the second material is silicon oxide.

According to one embodiment, a section of the central region of the waveguide has:
a tapered shape narrowing in the vicinity of the region in said phase-change material; or
a flared shape widening in the vicinity of the region in said phase-change material.

According to one embodiment, the switch further comprises a support substrate, the grating coupler being interposed between the support substrate and the region in said phase-change material.

According to one embodiment, the switch further comprises a reflective layer interposed between the support substrate and the grating coupler.

According to one embodiment, the reflective layer is in silicon or in silicon nitride.

According to one embodiment, the grating coupler is separated from the layer in said phase-change material by a distance greater than 100 nm.

According to one embodiment, the region in said phase-change material has a width in a range from 1 to 100 μm, preferably from 10 to 100 μm, more preferably from 30 to 100 μm.

According to one embodiment, the first and second conduction electrodes are part of an antenna element of a transmitarray or reflectarray cell.

According to one embodiment, said phase-change material is:
a chalcogenide material, preferably germanium telluride, antimony telluride or germanium-antimony-tellurium; or
vanadium dioxide.

### BRIEF DESCRIPTION OF THE DRAWINGS

The foregoing features and advantages, as well as others, will be described in detail in the following description of particular embodiments given on a non-limiting basis with reference to the accompanying drawings, in which:

FIG. 1A, FIG. 1B and FIG. 1C are schematic and partial views, respectively from above, in cross-section according to the plane BB in FIGS. 1A and 1n cross-section according to the plane CC in FIG. 1A, of an example of a phase-change material switch;

FIG. 2A and FIG. 2B are schematic and partial views, respectively from above and in cross-section according to the plane BB in FIG. 2A, of a phase-change material switch according to one embodiment;

FIG. 3 is a schematic and partial view from above of a variant of the switch of FIG. 2A;

FIG. 4A and FIG. 4B are schematic and partial views, respectively from above and in cross-section according to the plane BB in FIG. 4A, of a phase-change material switch according to one embodiment;

FIG. 5 is a cross-sectional, schematic and partial view of a grating coupler according to one embodiment; and

FIG. 6 is a cross-sectional, schematic and partial view of a grating coupler according to one embodiment.

### DESCRIPTION OF THE EMBODIMENTS

The same elements have been designated by the same references in the various figures. In particular, the structural and/or functional elements common to the various embodiments may have the same references and may have identical structural, dimensional and material properties.

For the sake of clarity, only the steps and elements useful for understanding the described embodiments have been shown and are detailed. In particular, the control circuits for the phase-change material switches and the applications in which such switches may be used have not been detailed, as the described embodiments and variants are compatible with the conventional control circuits for phase-change material switches and with the conventional applications using phase-change material switches.

Unless indicated otherwise, when reference is made to two elements connected to each other, this means directly connected without intermediate elements other than conductors, and when reference is made to two elements coupled to each other, this means that these two elements may be connected or coupled via one or more other elements.

In the following description, when reference is made to absolute position qualifiers, such as the terms “front”, “rear”, “top”, “bottom”, “left”, “right” etc., or to relative position qualifiers such as the terms “above”, “below”, “upper”, “lower,” etc., or to orientation qualifiers such as the terms “horizontal”, “vertical” etc., reference is made, unless indicated otherwise, to the orientation of the figures.

Unless indicated otherwise, the terms “about”, “approximately”, “significantly” and the expression “of the order of” mean within 10% or 10°, preferably within 5% or 5°.

In the following description, the terms “insulating” and “conducting” respectively mean electrically insulating and electrically conducting, unless indicated otherwise.

Unless indicated otherwise, the expression “in contact with” means “in mechanical contact with”.

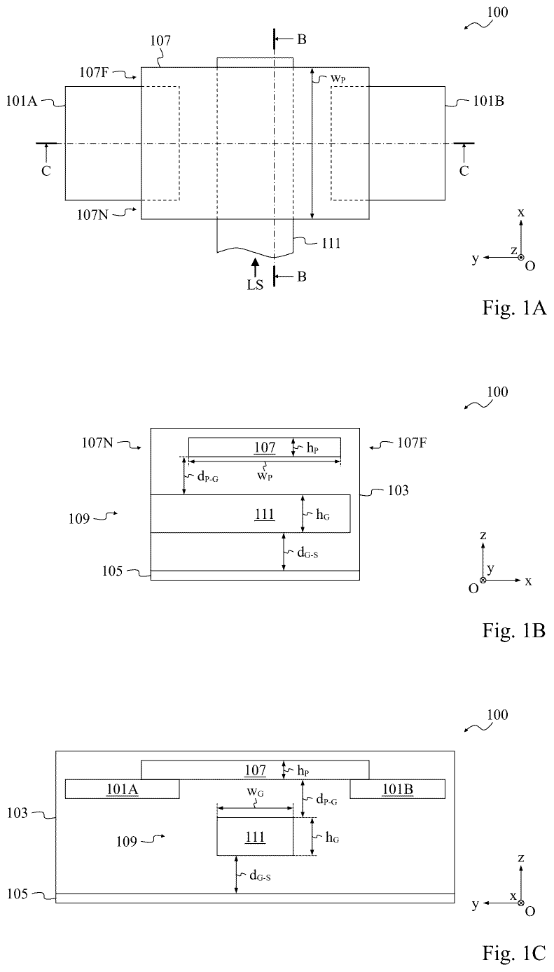

FIG. 1A, FIG. 1B and FIG. 1C are schematic and partial views, respectively from above, in cross-section according to the plane BB in FIGS. 1A and 1n cross-section according to the plane CC in FIG. 1A, of an example of a phase-change material switch 100. In the illustrated example, the plane BB is a vertical plane orthogonal to a conduction direction of the switch 100 and the plane CC is a vertical plane parallel to the conduction direction of the switch 100.

In FIGS. 1A to 1C, the conduction direction of the switch 100 is parallel to an axis Oy, the plane BB is parallel to a vertical plane Oxz, orthogonal to the axis Oy, and the plane CC is parallel to a vertical plane Oyz, orthogonal to an axis Ox.

In the shown example, the switch 100 comprises conduction electrodes 101A and 101B. The conduction electrodes 101A and 101B of the switch 100 are, for example, to be connected to a radio frequency communication circuit, not detailed in the figures. The conduction electrodes 101A and 101B are in a conducting material, for example in a metal such as copper or aluminum or in a metal alloy. Furthermore, the conduction electrodes 101A and 101B may have a single-layer or multi-layer structure.

In the illustrated example, the conduction electrodes 101A and 101B of the switch 100 are located in an insulating layer 103, for example in silicon oxide, coating a support substrate 105. As an example, the support substrate 105 is a wafer or wafer fragment in a semiconductor material, such as silicon. The conduction electrodes 101A and 101B of the switch 100 are, for example, part of an antenna element of a transmitarray or reflectarray cell.

In the shown example, the switch 100 further comprises a phase-change material region 107 connecting the conduction electrodes 101A and 101B. In the illustrated example, the phase-change material region 107 coats the upper face of a portion of the insulating layer 103 extending laterally between the electrodes 101A and 101B. In the shown example, the phase-change material region 107 extends over and in contact with a portion of the upper face of each conduction electrode 101A, 101B. In the illustrated example, the phase-change material region 107 has, as viewed from above, a substantially rectangular shape with a width w_{P}. The width w_{P} corresponds, in this example, to the lateral dimension of the region 107 measured along the axis Ox. The width w_{P} of the phase-change material region 107 is, for example, within a range from 1 to 100 μm, for example from 10 to 100 μm, for example from 30 to 100 μm. As an example, the phase-change material region 107 has a thickness hp, measured along the vertical axis Oz, of the order of 100 nm.

As an example, the phase-change material region 107 of the switch 100 is in a material known as “chalcogenide”, i.e. a material or an alloy comprising at least one chalcogen element, for example a material from the germanium telluride (GeTe), the antimony telluride (SbTe) or the germanium-antimony-telluride (GeSbTe, commonly referred to by the acronym “GST”) family. As a variant, the region 107 is in vanadium dioxide (VO₂).

In general, the phase-change materials are materials capable of alternating, under the effect of a temperature variation, between a crystalline phase and an amorphous phase, the amorphous phase having an electrical resistance higher than that of the crystalline phase. In the case of the switch 100, this phenomenon is exploited to obtain a blocked state, preventing the flow of a current between the conduction electrodes 101A and 101B, when the material in the region 107 located between the conduction electrodes 101A and 101B is in the amorphous phase, and a conducting state, allowing the flow of the current between the conduction electrodes 101A and 101B, when the material in the region 107 is in the crystalline phase.

In the shown example, the switch 100 further comprises a waveguide 109, for example an optical waveguide, located opposite the phase-change material region 107 and extending laterally along a main direction substantially orthogonal to the conduction direction of the switch 100 (along the direction Ox in the shown example). The waveguide 109 has, for example, a first end located opposite an upper face of the phase-change material region 107 and a second end, opposite the first end, to be illuminated by a laser source LS, for example a laser diode or a pulsed laser. The laser source LS is, for example, to emit a radiation constituting an optical signal to control the switch 100. The laser radiation emitted by the laser source LS propagates in the waveguide 109 in the form of an optical wave. As an example, the radiation emitted by the laser source LS has a transverse magnetic (TM) polarization or a transverse electric (TE) polarization. Furthermore, the radiation emitted by the laser source LS has, for example, a central wavelength λ₀ equal to approximately 915 nm. The central wavelength λ₀ of the laser source LS is equivalent to the wavelength at which the optical power emitted by the laser source LS is at its maximum. As an example, the central wavelength λ₀ of the laser source LS is chosen so that it is compatible with the integrated photonics and so that the phase-change material of the region 107 is absorbent at this wavelength.

In the illustrated example, the waveguide 109 comprises a central region 111, or core, surrounded by an insulating peripheral region, or cladding, formed, in this example, by a portion of the insulating layer 103. In the illustrated example, the central region 111 of the waveguide 109 extends parallel to the axis Ox. The central region 111 and the peripheral region of the waveguide 109 are in materials chosen so as to obtain a contrast in refractive indices that allows an optical mode of interest emitted by the laser source LS to be confined and guided. The material of the central region 111 of the waveguide 109 has, for example, a refractive index n_{E}, or optical index, strictly greater than a refractive index n_{O} of the peripheral region. In the case where the peripheral region is in silicon dioxide, the central region 111 of the waveguide 109 is, for example, in silicon nitride.

The plane CC in FIG. 1A is substantially orthogonal to a direction of propagation of the laser radiation in the waveguide 109. The direction of propagation of the laser radiation in the waveguide 109 is, in the illustrated example, parallel to the axis Ox. In the shown example, the peripheral region of the waveguide 109 coats the faces of the central region 111 parallel to the direction of propagation of the laser radiation (the lateral, lower and upper faces of the central region 111 of the waveguide 109 parallel to the axis Ox, in FIGS. 1A to 1C). More precisely, the peripheral region is in contact with the lateral, lower and upper faces of the central region 111. In this example, a portion of the peripheral region of the waveguide 109 extends vertically along the vertical axis Oz orthogonal to the horizontal axes Ox and Oy, from a face of the central region 111 located opposite the phase-change material region 107 (the upper face of the central region 111 of the waveguide 109, in the orientation of FIGS. 1B and 1C) to a face of the phase-change material region 107 located on the side of the conduction electrodes 101A and 101B (the lower face of the phase-change material region 107, in the orientation of FIGS. 1B and 1C).

In the shown example, the central region 111 has, in a cross-sectional view according to the plane CC orthogonal to the direction of propagation of the laser radiation in the waveguide 109, a cross-section of a substantially rectangular shape. As an example, the central region 111 has, in a cross-sectional view according to the plane CC, a width w_{G} (along the axis Oy) equal to approximately 2 μm and a height h_{G} (along the axis Oz) equal to approximately 315 nm. Furthermore, the central region 111 of the waveguide 109 is separated from the phase-change material region 107 by a distance d_{P-G}. In this example, the distance d_{P-G} is equivalent to a thickness of the portion of the peripheral region interposed between the central region 111 of the waveguide 109 and the phase-change material region 107. As an example, the distance d_{P-G} is less than or equal to 100 nm. In the illustrated example, the central region 111 of the waveguide 109 is additionally separated from the upper face of the support substrate 105 by a distance d_{G-S}. In this example, the distance d_{G-S} is equivalent to a thickness of the portion of the peripheral region interposed between the lower face of the central region 111 of the waveguide 109 and the upper face of the support substrate 105. As an example, the distance do-s is between one or more hundred nanometers and one or more micrometers, for example equal to approximately 1.5 μm.

The waveguide 109 is, for example, of a single-mode type, meaning that it is suitable for confining and guiding a single optical mode for each type of polarization. For example, the waveguide 109 is more precisely suitable for confining and guiding a single optical mode selected among a zero-order transverse electric mode (TE0), parallel to the axis Oy, and a zero-order transverse magnetic mode (TM0), parallel to the axis Oz. Because the modes TE0 and TM0 are orthogonal, they cannot couple each other in the waveguide 109. The choice of the mode confined and guided by the waveguide 109, between the mode TE0 and the mode TM0, is determined by the polarization of the laser source LS. Thus, in a case where the laser source LS emits a radiation with a transverse electric polarization TE, the waveguide 109 is suitable for confining and guiding the zero-order transverse electric mode TE0 only.

On the side of its end to be illuminated by the laser source LS, the waveguide 109 comprises, for example, an input coupling element, also known as the input surface of the waveguide 109. On the side of its end opposite the phase-change material region 107, the waveguide 109 may additionally comprise an output coupling element, also known as the output surface of the waveguide 109. The input coupling element may have a structure, for example a diffraction grating with a Bragg structure or any other coupling structure, for capturing the radiation emitted by the laser source LS and for propagating this radiation to the output surface.

In addition, the output surface of the waveguide 109 may have a structure that allows to re-emit the radiation propagated from the input surface toward the phase-change material region 107. In the shown example, the output coupling element consists of the portion of the waveguide 109 located vertically in line with the phase-change material region 107.

In general, the input and output surfaces of the waveguide 109 respectively allow, in the shown example, to receive and transmit a radiation or an optical wave in a direction orthogonal to the direction of propagation of the radiation or of the optical wave inside the waveguide 109, for example a direction parallel to the axis Oz. As a variant, at least one of the input and output surfaces of the waveguide 109, for example the input surface, may have a structure that allows to respectively receive or transmit a radiation or an optical wave in a direction parallel to the direction of propagation of the radiation or of the optical wave, inside the waveguide 109 (parallel to the axis Ox, in this example).

To toggle the switch 100 from the blocked state to the conducting state, the region 107 is heated by means of the laser source LS, by an evanescent coupling of the wave propagated by the waveguide 109, to a temperature T1 and for a duration d1. The temperature T1 and the duration d1 are chosen so as to cause a phase-change in the material of the region 107 from the amorphous phase to the crystalline phase. As an example, the temperature T1 is higher than a crystallization temperature and lower than a melting temperature of the phase-change material and the duration d1 is between 100 ns and 5 μs.

Conversely, to toggle the switch 100 from the conducting state to the blocked state, the region 107 is heated by means of the laser source LS, by an evanescent coupling of the wave propagated by the waveguide 109, to a temperature T2 higher than the temperature T1 and for a duration d2 shorter than the duration d1. The temperature T2 and the duration d2 are chosen so as to cause a phase-change in the material of the region 107 from the crystalline phase to the amorphous phase. As an example, the temperature T2 is higher than the melting temperature of the phase-change material and the duration d2 is in the range from 10 ns to 500 ns.

A disadvantage of the switch 100 is that the optical wave propagating in the waveguide 109 is not absorbed homogeneously in the phase-change material region 107 along the direction of propagation of the optical wave in the waveguide 109 (along the axis Ox, in this example). In the example of the switch 100, the optical wave is mainly absorbed by a first portion 107N of the phase-change material region 107. The portion 107N is closest to the laser source LS. The absorption of the optical wave is weaker in a second portion 107F of the phase-change material region 107, opposite the first portion 107N, which is further from the laser source LS than the portion 107N. The optical absorption of the wave by the phase-change material region 107 more precisely follows a decreasing exponential curve from the portion 107N of the region 107 to the portion 107F.

Thus, during an activation phase of the switch 100, the optical power absorbed by the second portion 107F of the region 107 may be insufficient to cause a phase-change in the material in the portion 107F. In the case of a switching from the conducting state to the blocked state, this may prevent the second portion 107F of the region 107 from changing phase from the crystalline phase to the amorphous phase, thereby undesirably allowing a leakage current to pass between the conduction electrodes 101A and 101B of the switch 100. This phenomenon is all the more likely to occur as the width w_{P} of the region 107 increases.

The inventors realized that the phenomenon comes from the fact that the transverse electric mode TE of the laser signal for activating the switch 100, which is confined and guided by the waveguide 109, is strongly absorbed by the phase-change material in the region 107, thus leading to a heating of the portion 107N that is much greater than that observed in the portion 107F. To overcome this problem, the geometry of the waveguide 109 could be modified to confine and guide only the transverse magnetic mode TM. However, the transverse magnetic mode TM is absorbed more strongly by the phase-change material in the region 107 than the transverse electric mode TE, which would amplify the phenomenon. As an example, the transverse magnetic mode TM exhibits losses, related to the absorption by the phase-change material in the region 107, of the order of 2 500 dB·cm⁻¹, compared to approximately 500 dB·cm⁻¹ for the transverse electric mode TE.

More generally, in both the transverse electric mode TE and the transverse magnetic mode TM, the absorbed optical power follows a law of the decreasing exponential curve type for this guide configuration, while the optical absorption law is constant. However, it would be preferable that the absorbed power follows a constant law, which could be ensured, for example, by a linear increasing optical absorption law, in order to modify the state of the phase-change material in the region 107. This would in particular compensate for the fact that less and less optical power remains in the guide as the optical power is absorbed.

In addition, switches based on a phase-change material optically actuated in a so-called “direct mode” have been proposed. In these switches, the phase-change material region is, for example, irradiated by a laser source focused on said region, the switches being, for example, devoid of waveguides between the laser source and the phase-change material region.

Such a switch is described in the article by A. Crunteanu et al. entitled “Optical Switching of GeTe Phase-change Materials for High-Frequency Applications” and published in 2017 following the conference “IEEE MTT-S International Microwave Workshop Series on Advanced Materials and Processes for RF and THz Applications (IMWS-AMP)”. In this article, a krypton fluoride (KrF) laser source emits a radiation with a wavelength of approximately 248 nm, for example in the form of pulses, to cause transitions in a phase-change material region of a switch between the amorphous and crystalline phases. A pulse with a fluence of the order of 90 mJ·cm⁻² is, for example, used to achieve a transition from the amorphous phase to the crystalline phase. In addition, another pulse with a fluence of the order of 185 mJ·cm⁻² is, for example, used to achieve a transition from the crystalline phase to the amorphous phase.

However, the switches based on a phase-change material optically actuated in a “direct mode” have disadvantages. In particular, these switches are incompatible with encapsulated component structures. Furthermore, each switch requires the use of a dedicated laser source. This prevents or greatly complicates the realization of integrated electronic components comprising several individually controllable switches.

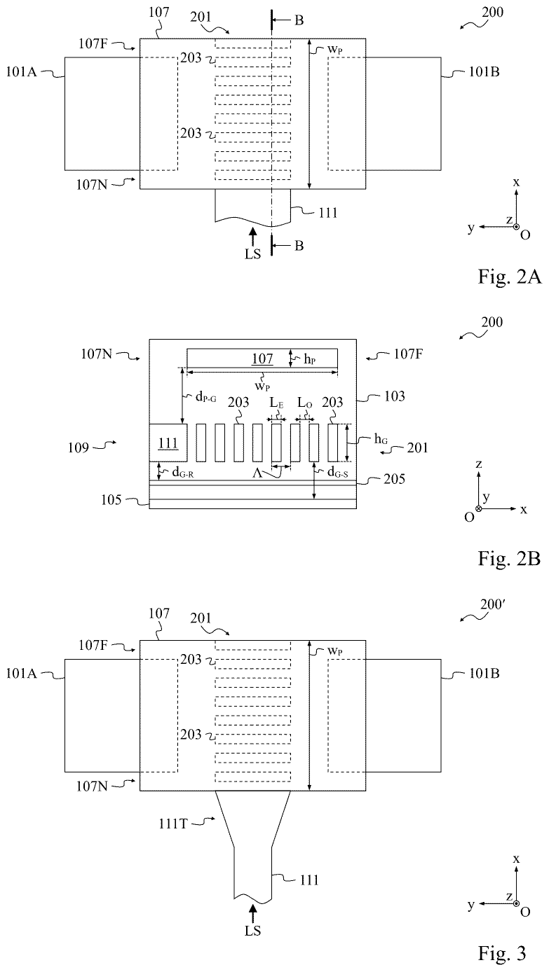

FIG. 2A and FIG. 2B are schematic and partial views, respectively from above and in cross-section according to the plane BB in FIG. 2A, of a phase-change material switch 200 according to one embodiment.

The switch 200 of FIGS. 2A and 2B includes elements common to the switch 100 of FIGS. 1A to 1C. These common elements will not be described in detail again below. The switch 200 of FIGS. 2A and 2B differs from the switch 100 of FIGS. 1A to 1C in that the output surface of the waveguide 109 of the switch 200 comprises a grating coupler 201, for example a Bragg grating coupler.

In the shown example, the grating coupler 201 is formed vertically in line with the phase-change material region 107. The grating coupler 201 comprises a plurality of regions 203 of a material having a refractive index n_{E} strictly greater than a refractive index n_{O} of the insulating layer 103. The regions 203 are separated laterally from each other by portions of the insulating layer 103. The optical control signal from the laser source LS thus traverses, along its direction of propagation, an alternation of media with different optical indices. As an example, each region 203 of the grating coupler 201 is in the same material as the central region 111 of the waveguide 109. This facilitates the construction of the switch 200, as the regions 111 and 203 are formed, for example, by etching the same layer.

Each region 203 has, for example, in a cross-sectional view according to a plane orthogonal to the direction of propagation of the laser radiation in the waveguide 109, a cross-section of a substantially rectangular shape, for example a cross-section identical, apart from manufacturing dispersions, to that of the central region 111 of the waveguide 109. In the shown example, each region 203 has a width L_{E}. The width L_{E} corresponds, in this example, to the lateral dimension of the region 203 measured along the horizontal axis Ox. Furthermore, in the shown example, each portion of the insulating layer 103 interposed laterally between two neighboring regions 203 has a width L_{O}. The width L_{O} corresponds, in this example, to the lateral dimension of the portion of the insulating layer 103 measured along the horizontal axis Ox.

In the illustrated example, the regions 203 of the grating coupler 201 are distributed in a substantially uniform manner, at a constant pitch, along the horizontal direction Ox. In addition, the regions 203 have identical dimensions, apart from manufacturing dispersions, and the portions of the insulating layer 103 interposed laterally between the regions 203 have identical dimensions, apart from manufacturing dispersions. In this example, the regions 203 and the portions of the insulating layer 103 interposed laterally between the regions 203 form a periodic structure with a period Λ. In the illustrated example, the period Λ of the grating coupler 201 corresponds to the sum of the widths L_{E} and L_{O}.

The period Λ is chosen according to the central wavelength λ₀ of the radiation propagated by the waveguide 109 and to an effective optical index n_{eff} resulting from the alternation of optical indices n_{E} and n_{O} along the direction of propagation, so as to verify the first-order Bragg condition defined by the following relationship:

$$Λ = \frac{{λ}_{0}}{{n}_{eff}} \qquad [ Math 1 ]$$

In the case where the central wavelength λ₀ is approximately equal to 915 nm, the period Λ of the grating coupler 201 is, for example, between 600 and 760 nm, for example approximately equal to 680 nm.

The effective optical index n_{eff} is defined by the following relationship:

$${n}_{eff} = F \cdot {n}_{E} - ( 1 - F ) \cdot {n}_{O} \qquad [ Math 2 ]$$

In the above relationship, the letter F denotes the filling factor of the grating coupler 201. The filling factor F is defined by the following relationship:

$$F = {F}_{0} - α x \qquad [ Math 3 ]$$

In the above relationship, α denotes a leakage factor of the grating coupler 201, x denotes the width of the switch 200 and F₀ denotes the initial filling factor, at the beginning of the grating coupler. In the shown example, the width x is, for example, equal to the width w_{P} of the phase-change material region 107. As an example, the width x is approximately equal to 20 μm.

The filling factor F of the grating coupler 201 thus allows the leakage factor α to be controlled. As an example, the filling factor F is in the range from 0.5 to 0.9.

In the shown example, the width L_{E} of the regions 203 is equal to the filling factor F multiplied by the period Λ of the grating coupler 201 (L_{E}=F·Λ) and the width L_{O} of the portions of the layer 103 interposed laterally between the regions 203 is equal to 1−F multiplied by the period Λ of the grating coupler 201 (L_{O}=(1−F)·Λ). In a case where the filling factor F is approximately equal to 0.5 and the period Λ is approximately equal to 680 nm, the width L_{E} is approximately equal to 340 nm and the width L_{O} is approximately equal to 340 nm.

In the illustrated example, an optical power P is guided into the grating coupler 201. The optical power P satisfies the following relationship, in which P₀ denotes the optical power supplied by the laser source LS, i.e. substantially the optical power present at the input of the grating coupler 201:

$$P = {P}_{0} {e}^{- 2 α x} \qquad [ Math 4 ]$$

Furthermore, the power P_{rad} radiated by the grating coupler 201 is defined by the following relationship:

$${P}_{rad} = - \frac{dP}{dx} = 2 α {P}_{0} {e}^{- 2 α x} \qquad [ Math 5 ]$$

The distance d_{G-S} separating the support substrate 105 from the central region 111 of the waveguide 109 has, for example, in the case of the switch 200, a value substantially equal to that chosen in the case of the switch 100. As an example, the distance d_{G-S} is, in the case of the switch 200, between one or more hundred nanometers and one or more micrometers, for example equal to approximately 1.5 μm.

In the shown example, the switch 200 further comprises a reflective layer 205, or mirror layer, interposed between the support substrate 105 and the grating coupler 201. The reflective layer 205 allows the optical power radiated toward the support substrate 105 to be reflected back toward the phase-change material region 107. As an example, the reflective layer 205 is in silicon or in silicon nitride.

In the illustrated example, the grating coupler 201 is separated from the reflective layer 205 by a distance d_{G-R}. As an example, the distance do-R is in the range from 100 to 700 nm.

The distance d_{P-G} separating the phase-change material region 107 from the central region 111 of the waveguide 109 has, in the case of the switch 200, a value greater than that chosen in the case of the switch 100. In the case of the switch 200, the distance d_{P-G} is, for example, within a range from 100 to 300 nm, whereas the distance d_{P-G} is, for example, within a range from 0 to 100 nm in the case of the switch 100.

Unlike the switch 100, in which the optical power of the control signal from the laser source LS is transferred from the waveguide 109 to the phase-change material region 107 by an evanescent coupling, the structure of the switch 200 allows the optical power to be transferred from the grating coupler 201 to the region 107 by a direct irradiation. Compared to the switch 100, this has the advantage of avoiding the high absorption of the optical wave in the vicinity of the portion 107N of the phase-change material region 107 close to the laser source LS and of better distributing the absorption along the axis Ox. It also makes it possible to provide for a greater distance d_{P-G}, which facilitates the implementation of the switch 200.

FIG. 3 is a schematic and partial view from above of a variant 200′ of the switch 200 of FIG. 2A.

In the illustrated example, the central region 111 of the waveguide 109 has, in the vicinity of the phase-change material region 107, a section 111T with a flared shape. In this case, the section 111T has an increasing width along the axis Ox and allows the light energy to be distributed under the phase-change material to be switched. This has the advantage of switching a larger area of phase-change material, thus obtaining a more efficient switch with a lower blocked state capacitance C_{off}. The variant 200′ illustrated in FIG. 3 allows optical waves to be transmitted over a greater length of phase-change material than in the case of the switch 200 in FIGS. 2A and 2B. The length of phase-change material is considered along the axis Oy, between the conduction electrodes 101A and 101B. In the case of the variant 200′, the optical power is, for example, greater than that used in the case of the switch 200 so that the phase-change material in the region 107 reaches its melting or crystallization temperature.

As a variant, the section 111T may have a tapered shape. In this case, the section 111T has a decreasing width along the axis Ox and allows the light energy to be concentrated under the phase-change material to be switched. This advantageously reduces the level of light intensity required for switching.

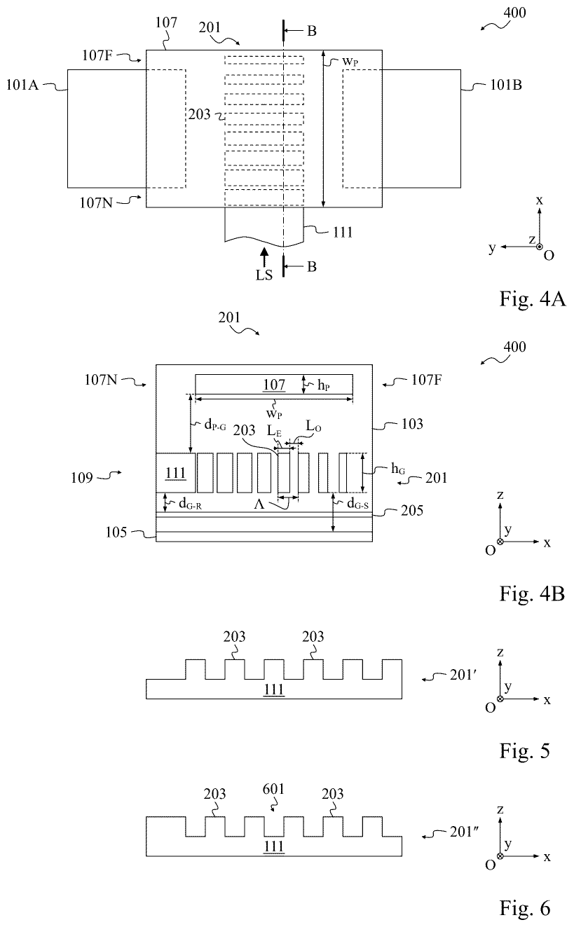

FIG. 4A and FIG. 4B are schematic and partial views, respectively from above and in cross-section according to the plane BB in FIG. 4A, of a phase-change material switch 400 according to one embodiment.

The switch 400 in FIGS. 4A and 4B comprises elements that are common with the switch 200 in FIGS. 2A and 2B. These common elements will not be described in detail again below. The switch 400 in FIGS. 4A and 4B differs from the switch 200 in FIGS. 2A and 2B in that the grating coupler 201 of the switch 400 is apodized.

In the shown example, the grating coupler 201 of the switch 400 has a substantially constant period A and a variable filling factor F. More precisely, the filling factor F decreases along the direction of propagation of the control signal in the grating coupler 201 of the switch 400, i.e. along the direction Ox in the shown example. In other words, the filling factor F is greater in the vicinity of the portion 107N of the phase-change material region 107 than in the vicinity of the portion 107F. In this example, the width L_{E} of the regions 203 decreases along the direction Ox and the width L_{O} of the portions of the insulating layer 103 extending laterally between the regions 203 increases along the direction of propagation of the control signal. This allows the grating coupler 201 to irradiate less optical power in the vicinity of the portion 107N of the phase-change material region 107 than in the vicinity of the portion 107F.

An advantage of the switch 400 above described in relation to FIGS. 4A and 4B is that the presence of the apodized grating coupler 201 ensures that the control laser signal of the switch 400 is absorbed substantially uniformly by the phase-change material of the region 107. More specifically, in the case of the switch 400, the transverse electric mode TE is absorbed more weakly perpendicular to the portion 107N of the region 107 and more strongly perpendicular to the portion 107F of the region 107. This prevents, compared to the switch 100 in FIGS. 1A and 1B, a portion of the phase-change material region 107, for example the portion 107F furthest from the laser source LS, from changing phase when the switch is controlled.

The integration of the switch 400 above described is particularly advantageous in radio frequency communication electronic devices, for example. Indeed, for this type of application, it is very advantageous to have switches with a large width w_{P}, for example in the order of a few tens of micrometers, as this reduces the resistive losses in the conducting state compared to switches with a smaller width w_{P}. In addition, the integration of the switch 400 makes it possible to limit the occurrence of parasitic capacitance phenomena and to switch more intense electrical signals. However, this example is not limiting, and those skilled in the art can of course take advantage of the benefits of the switch 400 in many applications other than radio frequency communication applications.

FIGS. 4A and 4B illustrate an example of implementation of a switch 400 in which the regions 203 of the grating coupler 201 are distributed evenly, at a constant pitch, vertically in line with the phase-change material region 107. However, this example is not limiting, and a person skilled in the art would be able to foresee, as a variant, other structures of the grating coupler 201, which are designed to enable the grating coupler 201 to irradiate a constant optical power along the direction of propagation of the control signal from the laser source LS. These structures are within the skill of a person skilled in the art upon reading the present description. As an example, a person skilled in the art is able to foresee that the grating coupler has a constant filling factor F and an increasing period Λ along the direction of propagation of the control signal.

FIG. 5 is a cross-sectional, schematic and partial view of a grating coupler according to one embodiment. FIG. 5 illustrates, for example, a variant embodiment 201′ of the grating coupler 201 of the switch 200 of FIGS. 2A and 2B, it being understood that a person skilled in the art is able, upon reading the present description, to adapt this variant to the grating coupler 201 of the variant 200′ of FIG. 3 and to that of the switch 400 of FIGS. 4A and 4B.

In the shown example, the regions 203 of the grating coupler 201′ protrude from the upper face of the central region 111 of the waveguide 109. The regions 203 have, for example, a notch shape.

FIG. 6 is a cross-sectional, schematic and partial view of a grating coupler according to one embodiment. FIG. 6 illustrates, for example, a variant embodiment 201″ of the grating coupler 201 of the switch 200 of FIGS. 2A and 2B, it being understood that a person skilled in the art is able, upon reading the present description, to adapt this variant to the grating coupler 201 of the variant 200′ of FIG. 3 and to that of the switch 400 of FIGS. 4A and 4B.

In the shown example, the regions 203 of the grating coupler 201″ laterally delimit trenches extending, from the upper face of the central region 111 of the waveguide, into the thickness of the region 111. The regions 203 have, for example, a notch shape.

Various embodiments and variants have been described. Those skilled in the art will understand that certain features of these various embodiments and variants could be combined, and other variants will be apparent to those skilled in the art. In particular, the variant 200′ of FIG. 3 can be combined with the embodiment of FIGS. 4A and 4B, i.e. the person skilled in the art is, for example, able to foresee, in the switch 400, that the central portion 111 of the waveguide 109 has a tapered section 111T flaring along the direction of propagation of the control signal of the switch 400.

Finally, the practical implementation of the embodiments and variants described is within the reach of a person skilled in the art based on the functional indications given above. Although FIGS. 2A, 2B, 3, 4A and 4B illustrate examples of embodiments of the switches 200, 200′ and 400 in which the grating coupler 201 is interposed vertically between the support substrate 105 and the phase-change material region 107, this example is not limiting, and the switches 200, 200′ and 400 may, as a variant, have a structure in which the phase-change material region 107 is interposed vertically between the support substrate 105 and the grating coupler 201. In this variant, the reflective layer 205 is, for example, formed on the side of a face of the grating coupler 201 opposite the support substrate 105.

Furthermore, the embodiments described are not limited to the specific examples of materials and dimensions mentioned in the present description.

1. A phase-change material switch comprising:
a region in said phase-change material connecting first and second conduction electrodes of the switch; and
a grating coupler for coupling a laser signal for activating the switch, located opposite a face of the region in said phase-change material and separated from the region in said phase-change material by a distance in a range from 100 to 300 nm,
grating coupler comprises, vertically in line with the region in said phase-change material, an alternation of first regions in a first material having a first optical index and of second regions in a second material having a second optical index strictly lower than the first optical index.

2. The switch according to claim 1, wherein the grating coupler is configured to irradiate a constant optical power along a direction of propagation of the laser signal for activating the switch.

3. The switch according to claim 2, wherein the first regions are distributed at a constant pitch and have a width decreasing along the direction of propagation of the laser signal for activating the switch.

4. The switch according to claim 1, wherein the grating coupler is configured to irradiate a decreasing optical power along a direction of propagation of the laser signal for activating the switch, the first regions being distributed at a constant pitch and having a constant width.

5. The switch according to claim 1, wherein the grating coupler is located in the extension of a waveguide, the waveguide comprising a central region in said first material surrounded by a peripheral region in said second material.

6. The switch according to claim 5, wherein the first material is silicon nitride and the second material is silicon oxide.

7. The switch according to claim 5, wherein a section of the central region of the waveguide has:
a tapered shape narrowing in the vicinity of the region in said phase-change material; or
a flared shape widening in the vicinity of the region in said phase-change material.

8. The switch according to claim 1, further comprising a support substrate, the grating coupler being interposed between the support substrate and the region in said phase-change material.

9. The switch according to claim 8, further comprising a reflective layer interposed between the support substrate and the grating coupler.

10. The switch according to claim 9, wherein the reflective layer is in silicon or in silicon nitride.

11. The switch according to claim 1, wherein the grating coupler is separated from the layer in said phase-change material by a distance greater than 100 nm.

12. The switch according to claim 1, wherein the region in said phase-change material has a width in a range from 1 to 100 μm, preferably from 10 to 100 μm, more preferably from 30 to 100 μm.

13. The switch according to claim 1, wherein the first and second conduction electrodes are part of an antenna element of a transmitarray or reflectarray cell.

14. The switch according to claim 1, wherein said phase-change material is:
a chalcogenide material, preferably germanium telluride, antimony telluride or germanium-antimony-tellurium; or
vanadium dioxide.
